(19) United States
(12) Patent Application Publication
(10) Pub. No.: US 2019/0323190 A1
(43) Pub. Date: Oct. 24, 2019

(54) SNOW REMOVAL EQUIPMENT

(71) Applicant: THE KOBI COMPANY, Heverlee (BE)

(72) Inventors: Steven WAELBERS, Heverlee (BE); Sebastiaan DE BACKER, Mechelen (BE); Bastiaan WINNELINCKX, Leuven (BE); Mart-Joren VERSTEDEN, Tielt (BE)

(21) Appl. No.: 16/306,606

(22) PCT Filed: Jun. 5, 2017
(86) PCT No.: PCT/EP2017/063633

§ 371 Date: Dec. 3, 2018

(30) Foreign Application Priority Data
Jun. 3, 2016 (BE) 2016/5417

(51) Int. Cl. E01H 5/09; G05D 1/00; G05D 1/02; A46B 7/04

(52) U.S. Cl. CPC E01H 5/098; G05D 1/0011; G05D 1/021; A01D 34/008; E01H 5/092; A46B 7/04; G05D 1/0221

(57) ABSTRACT

A snow removal equipment is described. The snow removal equipment comprises a propulsion means allowing the snow removal equipment to move on a terrain, a gathering unit adapted for gathering or shoveling snow on the terrain, and a disposal unit to remove the gathered snow. The snow removal equipment has been adapted to allow the speed at which the snow on the terrain is gathered, and the speed at which the gathered snow is removed, to be controlled separately.

### FIELD OF THE INVENTION

The invention generally relates to a snow removal equipment, in particular, to a snow removal equipment for small-scale and/or personal use, suitable for removing snow from, for example, a driveway, car park, or footpath or the like. The invention also relates to a method of controlling such a snow removal equipment, and a computer program.

### BACKGROUND OF THE INVENTION

Motorised snow removal equipment for small-scale use are known in the prior art. Typically, two types can be distinguished:

(1) a first type where the snow removal equipment has a curved, inclined plate mounted in front, with which the snow is pushed to the side of the snow removal equipment when the snow removal equipment moves forward,
(2) a second type where the snow is shovelled or scraped up, and thrown into the air so that the snow falls down again at a distance from the snow removal equipment. This type is usually more suitable for snow removing of larger surfaces.

The present invention focuses on the second type of snow removal equipment. An example of a shovelling or scraping system that can be used in such a snow removal equipment 100 is described, for example, in WO9914439A1, and is shown in FIG. 1.

Existing systems, however, have the disadvantage that under certain circumstances ice formation and blockage can occur and/or that they work less efficiently.

### SUMMARY OF THE INVENTION

It is an object of the present invention to provide a good motorised snow removal equipment of the type where snow is shovelled or scraped up and thrown into the air.

It is an advantage of embodiments of the present invention that a motorised snow removal equipment is provided, where the risk of blockage is greatly reduced or even eliminated.

It is an advantage of embodiments of the present invention that a motorised snow removal equipment is provided that removes snow efficiently.

These objects are achieved by a snow removal equipment comprising a propulsion means allowing the snow removal equipment to move on a terrain. The snow removal equipment further comprises a gathering unit adapted for gathering or shovelling snow on the terrain as well as a disposal unit to remove the gathered snow. It is a characteristic of embodiments according to the first aspect that the snow removal equipment is adapted such that gathering the snow on the terrain and removing the gathered snow can be controlled separately. In some embodiments, the snow removal equipment has been adapted such that the speed at which the snow on the terrain is gathered, and the speed at which the gathered snow is removed, can be controlled separately.

In a second aspect, the present invention comprises a method for removing snow using the snow removal equipment as described in an embodiment of the first aspect. The method further comprises controlling a gathering unit adapted for gathering or shovelling snow on the terrain, and the removal of the gathered snow from the snow removal equipment, where controlling the gathering unit and removing the gathered snow are controlled separately. In some embodiments, the speed at which the gathering unit is driven and the speed at which the gathered snow is removed can be controlled separately. In some embodiments, the gathering unit may also be driven in an opposite direction, for example, if the system threatens to clog.

In a third aspect, the present invention comprises a computer program product that provides the functionality of the methods according to embodiments of the present invention.

In a fourth aspect, the present invention comprises a snow removal equipment comprising propulsion means allowing the snow removal equipment to move on a terrain, a gathering unit adapted for gathering or shovelling snow on the terrain, and a disposal unit to remove the gathered snow. The snow removal equipment also includes a heating element adapted to heating snow or ice in the snow removal equipment, for example, if this is threatening to clog the system and possibly stall.

In a fifth aspect, the present invention comprises a snow removal equipment provided with a sensor system to perform an analysis of the snow which is positioned in front of the snow removal equipment. The system is further adapted to adjust the speed or the force at/with which the snow must be removed based on the snow analysis. The analysis may be a type of snow, such as powder snow or compact snow, and/or a quantity of snow, such as, for example, layer thickness, etc.

In a sixth aspect, the present invention comprises a snow removal equipment which can remove autonomously, without the intervention of an operator.

Particular and preferred aspects of the invention are set out in the appended independent and dependent claims and/or in embodiments described in the detailed description of illustrative embodiments. Features of the dependent claims may be combined with features of the independent claims and with features of other dependent claims as appropriate and not merely as explicitly set out in the claims.

For purposes of summarising the invention and the advantages achieved over the prior art, certain objects and advantages of the invention have been described herein above. Of course, it is to be understood that not necessarily all such objects or advantages may be achieved according to any particular embodiment of the invention. Consequently, persons who are skilled in this matter, will, for example, recognise that the invention may be embodied or carried out in a way that achieves one advantage or a group of advantages as described herein, without necessarily achieving other objects or advantages that are described or suggested herein.

The above and other aspects of the invention will be apparent from and elucidated with reference to the embodiment(s) described hereinafter.

### BRIEF DESCRIPTION OF THE DRAWINGS

The invention will now be further described, by way of example, with reference to the accompanying drawings in which:

FIG. 1 shows a prior art apparatus that can be used for removing snow.

FIG. 2 shows an illustrative embodiment of a snow removal equipment according to the present invention.

FIG. 3 is an example of a snow removal equipment module that can be coupled to a mobile system, according to an embodiment of the present invention.

FIG. 4 illustrates a bottom view of a snow removal equipment, according to an embodiment of the present invention.

FIG. 5 illustrates a schematic overview of components of a snow removal equipment, according to an embodiment of the present invention.

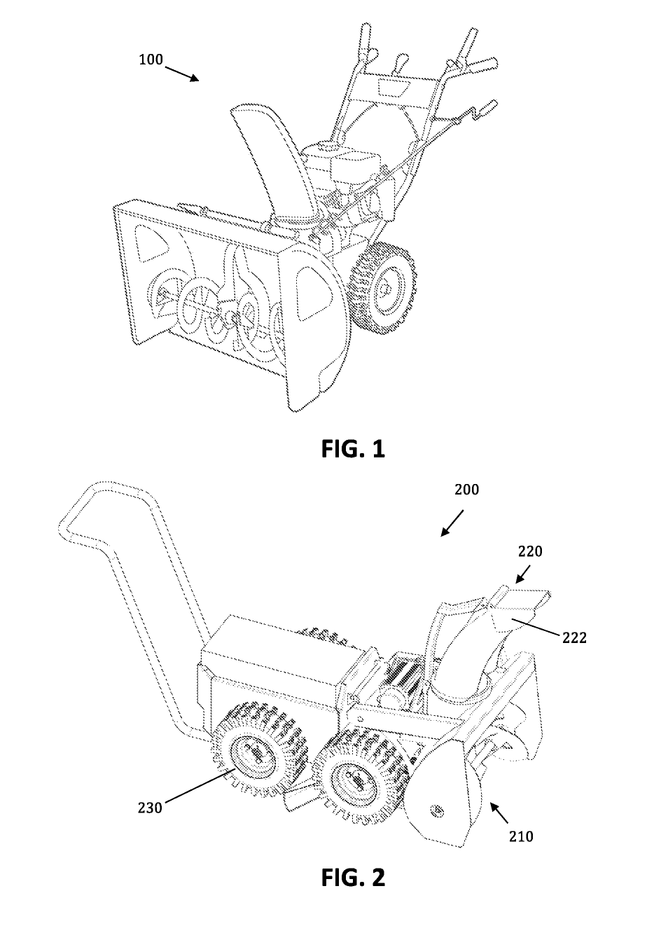

The drawings are only schematic and are non-limiting. In the drawings, the size of some of the elements may be exaggerated and not drawn to scale for illustrative purposes. The dimensions and the relative dimensions do not necessarily correspond to actual reductions to practice of the invention. Any reference signs in the claims shall not be construed as limiting the scope. In the different drawings, the same reference signs refer to the same or analogous elements.

### DETAILED DESCRIPTION OF EMBODIMENTS OF THE INVENTION

The present invention will be described with reference to particular embodiments and with reference to particular drawings, but the invention is not limited thereto and is limited only by the claims.

It should be noted that the term ‘comprising’, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression ‘a device comprising means A and B’ should not be limited to devices consisting only of components A and B. It means that with respect to the present invention, the only relevant components of the device are A and B.

Reference throughout this specification to ‘one embodiment’ or ‘an embodiment’ means that a particular feature, structure or characteristic described in connection with the embodiment is included in at least one embodiment of the present invention. Thus, appearances of the phrases ‘in one embodiment’ or ‘in an embodiment’ in various places throughout this specification may, but do not necessarily, all refer to the same embodiment. Furthermore, the particular features, structures or characteristics may be combined in any suitable manner, as would be apparent to one of ordinary skill in the art from this disclosure, in one or more embodiments.

Similarly it should be appreciated that in the description of illustrative embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. The claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Where in embodiments of the present invention reference is made to a gathering unit, reference may be made to any suitable unit for gathering or shovelling snow, such as for example also referred to as an auger.

In the description provided herein, numerous specific details are set forth. However, it is understood that embodiments of the invention may be practised without these specific details. In other instances, well-known methods, structures and techniques have not been shown in detail in order not to obscure an understanding of this description.

Where reference is made in this application to ‘amount of snow’, unless explicitly stated otherwise, an absolute amount is meant, which is, for example, measured, analysed, processed or recorded, during a predetermined period.

Where reference is made in this application ‘snow flow rate’, unless explicitly stated otherwise, an average flow rate is meant, during a predetermined period.

In this application, the terms ‘shovelling’ or ‘scraping’ or ‘gathering’ of snow are used as synonyms, regardless of how it is done physically.

In this application, the terms ‘blowing’ or ‘blowing away’ or ‘casting away’ of snow are used synonymously, regardless of how it is done physically.

In a first aspect, the present invention relates to a snow removal equipment. Although the present invention may also have additional functionality, for example, by changing a module, the system in the first aspect has at least the functionality of removing snow. According to embodiments of the present inventions, the snow removal equipment comprises propulsion means allowing the snow removal equipment to move on a terrain. The snow removal equipment further comprises a gathering unit adapted for gathering or shovelling snow on the terrain as well as a disposal unit to remove the gathered snow. It is a characteristic of embodiments according to the first aspect that the snow removal equipment is adapted such that gathering the snow on the terrain and removing the gathered snow can be controlled separately. In some embodiments, the snow removal equipment has been adapted such that the speed at which the snow on the terrain is gathered, and the speed at which the gathered snow is removed, can be controlled separately. It is an advantage of such control that the risk of blockage is greatly reduced or eliminated. In addition, it is an advantage of such control that it results in a more efficient removal of snow. The amount of snow removed by the disposal unit can be, for example, a predetermined maximum value. According to some embodiments, the snow removal equipment is an unmanned snow removal equipment. However, the system may also be provided with a handle to manually operate it, if necessary. This is advantageous given that no operator is required and the snow removal equipment can operate independently. According to some embodiments, snow gathering on the terrain and removing the gathered snow can be independently controlled.

By way of illustration, embodiments of the present invention not limited thereby, standard and optional elements of an illustrative snow removal equipment will be described in more detail. Different embodiments may include several of these elements or components without the need for all of these elements to be present in all embodiments.

The snow removal equipment typically comprises propulsion means allowing the snow removal equipment to move on a terrain. The propulsion means can be, for example, wheels or caterpillar tracks. Wheels have the advantage that the snow removal equipment is more agile, and the maximum speed is greater. Caterpillar tracks have the advantage that the snow removal equipment can easily drive over small obstacles (e.g. boulders or ice), reducing or minimising the chance of the snow removal equipment getting stuck. In embodiments where wheels are used, the snow removal equipment may comprise 2, 4 or 6 wheels in some examples. In preferred embodiments, the propulsion of the snow removal equipment is motorised, although the present invention is not limited thereto. The propulsion means can all be driven or partially driven. In addition, they can be driven separately or together, i.e., by the same or different engines. In one embodiment, the wheels are all driven, which further reduces the chance of the snow removal equipment getting stuck. Preferably, a flexible suspension system is also used, so that the snow removal equipment can easily move on ground that is not completely flat.

In some embodiments, the snow removal equipment is made such that it has a base module supported by at least two wheels. This base module can include, for example, one or more engines, but also sensors and safety systems. In addition, the illustrative snow removal equipment also comprises the snow removing module, which is supported by at least one, and preferably also by at least two wheels. The snow removing module comprises the vanes for shovelling the snow as well as the disposal unit to remove the snow. The snow removing module can also comprise additional components such as a brush, sensors, safety systems, etc. (some of these can also be integrated into the base module). Both modules can be permanently attached to each other or can be interconnectable. In some embodiments, in which the modules are interconnectable, the base module can also be coupled to a leaf blower module, a leaf vacuum module, a lawn mower module, a grass mulching module, an aerating module, etc. The snow removal equipment can thus also be used for other functions, in addition to snow removal, by changing the implementation module. The system can be adapted with a quick-change system, allowing the different modules to be changed quickly and efficiently. The base module can be equipped with a stand, to keep the module stable during changing.

As stated above, the snow removal equipment comprises vanes for shovelling the snow. Such a gathering unit can, for example, be a screw pump, or a set of blades, and allows the snow to be loosened and shovelled. It is typically located in the snow removing module. The gathering unit can be a single-stage system or a double-stage system, with a second set of vanes. The latter can allow a higher snow height to be removed more easily. The gathering unit can typically be driven via a transmission system which may comprise, for example, a drive belt, but other motion transmission systems may also be used. The gathering unit is typically driven by a motor. Such a motor can be an electric motor, a petrol engine, a diesel engine, a hybrid engine, etc. For electric driving, one or more batteries may also be provided. The vanes, for example, vane-shaped elements or blades, can be coated with a layer. Such a layer may, for example, have an anti-oxidising function, that provides better contact resistance with the snow, etc.

In some embodiments, the snow removal equipment additionally comprises a chamber wherein the gathering unit is adapted for transporting the gathered snow to a chamber, and wherein the disposal unit (described below) is connected to the chamber and adapted to remove snow from the chamber.

As indicated above, the snow removal equipment also comprises a disposal unit. Such a disposal unit typically provides a system where the snow is removed from the snow removal equipment, for example, by casting or blowing the snow away to a place between a few metres and up to 30 metres further. The disposal unit may in some embodiments be based on an Archimedean screw (screw pump system) for casting away the snow, or in other embodiments be based on a blowing system for blowing away the snow. Other systems allowing snow to be cast away or blown away with great force can also be used. The disposal unit typically also comprises an ejection element, allowing the snow to be cast away at high speed. The ejection element can be made of any type of material, for example, of plastic. It can be firmly mounted on the snow removing module or it can be flexibly mounted so that the direction in which the snow is removed can be chosen. In some embodiments, the ejection element may even be driven so that the direction in which snow is removed relative to the snow removal equipment is automatically selected, for example, in conjunction with automatic control of the system.

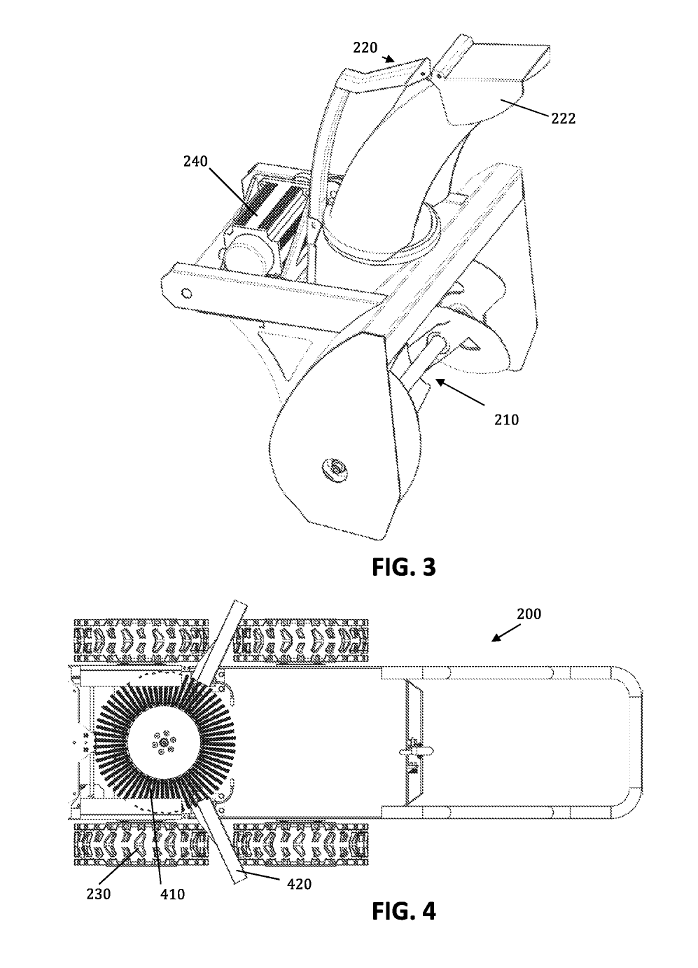

By way of illustration, an illustrative snow removal equipment is shown in FIG. 2 and a snow removing module is shown separately in FIG. 3.

FIG. 2 shows an example of a snow removal equipment 200 in which a gathering unit 210 is present for gathering the snow on the surface, as well as a disposal unit 220 for removing the gathered snow. The ejection element 222 is also shown in the disposal unit 220. A set of wheels 230 is also shown, on which the illustrative system 200 moves. More specifically, in FIG. 2, the gathering unit and the disposal unit share the same screw pump system. In an embodiment such as FIG. 2, the gathering speed is determined by the speed at which the gathering unit operates and the speed of advancement. In this particular embodiment, the removal speed and the gathering speed can therefore be controlled separately by controlling the speed of the gathering unit and the advancement speed separately. It will be apparent to those skilled in the art that the gathering unit and the disposal unit can also be separate elements, where the gathering speed and the removal speed can be controlled separately by controlling the gathering unit and the disposal unit separately.

FIG. 3 shows a detail drawing of the snow removing module, in which the gathering unit 210 and the disposal unit 220 are shown again. FIG. 3 also shows a drive system 240, in the present example, the drive system 240 for the disposal unit 220.

As mentioned above, the snow removal equipment is adapted to, for example, control the speed at which the snow is gathered independently from the speed at which the snow is removed from the snow removal equipment. This can be achieved in different ways. The speed at which the snow is gathered is affected by the speed at which the snow removal equipment advances and the speed at which the gathering unit is operating. The speed at which the snow is removed is affected by either the speed at which the gathering unit is operating (if the removal is based on the gathering unit), or the speed of a separate system with which the snow is pushed away or blown away. The system is therefore controlled such that the shovelling speed and the removal speed are unlinked.

In one embodiment, this is obtained by controlling the advancement speed separately and controlling the removal speed separately (the latter can be achieved by controlling the gathering unit if it also being used for the removal, or by controlling the removal element).

In another embodiment, wherein the disposal unit is independent of the gathering unit, this can be achieved by separately controlling the speed of the gathering unit and the speed of, for example, an Archimedean screw or blowing system of the disposal unit.

The independent control can be achieved by providing separate motors for these elements. Alternatively, a single engine can be used wherein different connections allow different speeds to be generated for the different elements. In embodiments of the snow removal equipment according to the present invention, one, two or three motors may be provided. It is an advantage of a snow removal equipment with two engines that it offers a relatively high degree of flexibility with regard to the gathering and removal functions, while still being relatively cheap to manufacture. It is an advantage of a snow removal equipment with three engines that it can be more flexibly controlled because the gathering, removal and movement functions can be controlled completely independently.

The engine or engines used may be an electric motor, a spark-ignition engine such as a petrol engine or a diesel engine, a hybrid engine, etc. For electric driving, one or more batteries may also be provided.

In some embodiments, the snow removal equipment comprises a controller for coordinating the speed at which the snow on the terrain is gathered, with the speed at which the gathered snow is removed. It is an advantage of embodiments of the present invention that blockage by ice formation can be reduced or avoided. In addition, the snow can also be removed more efficiently. The controller can perform the coordination of the gathering speed and the removal speed based on an algorithm, based on a self-learning network, etc.

In some embodiments, the snow removal equipment comprises a motor (M1) for driving the gathering unit and a motor (M2) for driving the disposal unit, the motor (M1) for driving the gathering unit and the motor (M2) for driving the disposal unit being separately drivable. The controller may be adapted to individually control the speed at which the gathering unit operates and the speed at which the disposal unit operates. In this preferred embodiment of a snow removal equipment according to the present invention, the speed at which the snow is blown away is coordinated with the speed at which the snow is gathered, without necessarily affecting the speed at which the removal equipment is driven. This allows the speed of the disposal unit to be increased to avoid a blockage, and also allows the speed of the disposal unit to be reduced at places where this is possible (e.g., when the snow is less high). In this way, power can be saved, which increases the autonomy of the vehicle.

The controller can be programmed to reduce the speed at which the gathering unit is driven if the snow cannot be removed sufficiently quickly. The controller can also be programmed to reduce the speed at which the disposal unit is driven if the snow cannot be removed sufficiently quickly. The controller can also be adapted to slow down the snow-gathering engine (M1) with respect to the snow-removal engine (M2) and/or accelerate the snow-removal engine (M2) relative to the snow-gathering engine (M1) if the amount of snow gathered or shovelled by the gathering unit is greater than the amount of snow removed by the disposal unit.

A motor for driving the gathering unit can also be used simultaneously for driving the propulsion means. Alternatively, the snow removal equipment may comprise one or more separate motors (M3) for driving the propulsion means. In a preferred embodiment of a snow removal equipment according to the present invention, the speed of the vehicle is adjusted to the amount of snow being shovelled. For example, if there is a higher amount of snow on the terrain, the vehicle will slow down so that the disposal unit has enough time to dispose of the amount of snow gathered. Indeed, the amount of snow gathered is substantially proportional to the speed of the vehicle, and thus with the speed of the first engine.

The controller may be adapted to individually control the speed at which the propulsion means are driven and the speed at which the disposal unit is driven. The controller can also be programmed to reduce the speed at which the propulsion means are driven if the snow cannot be removed sufficiently quickly. In some embodiments, the controller is programmed to set at least one intermediate speed between 0 km/h and the maximum speed at which the propulsion means can be driven. In addition, the system can be adapted for reversing the direction of movement.

In some embodiments, the snow removal equipment is furthermore equipped with a brush for sweeping the surface to rub loose any residual snow, after the snow has been gathered by means of the screw pump system. Such a brush may, for example, be a flat rotating brush positioned under the front wheels. An example of such a brush is shown in FIG. 4. In addition to the brush 410, flexible guides 420, e.g. flaps, may also be provided to guide the residual snow to a suitable position.

In some embodiments, the snow removal equipment also comprises one or more sensors for detecting the accumulation of snow or ice formation. Such sensor(s) allow it to be determined how much snow is being processed at different places within the snow removal equipment. Such a sensor may be, for example, an optical sensor or a camera. This can be in the chamber if it is present, or in another place where snow accumulation and ice formation can be a problem. The sensor can also be a weight sensor. In yet another embodiment, the snow removal equipment comprises a sensor for measuring the power output of the at least one engine for advancing the snow removal equipment. The controller may be programmed to control the different motors based on an input signal from the at least one sensor.

For example, the input signal may indicate when the amount of snow in the chamber exceeds a predetermined value, when the fill ratio of the chamber is greater than a predetermined value, when the amount or flow rate or average flow rate of snow entering the chamber via the gathering unit is greater than the amount or flow rate of snow leaving the chamber via the disposal unit, or when ice formation is detected. In such embodiments, the processor receives an appropriate signal from the sensor, and can take appropriate action based on that signal to prevent clogging.

In some embodiments, the snow removal equipment may include a controller programmed for automated snow removing, without an operator having to control the snow removal equipment. The controller then controls the snow removal equipment in such a way that it removes snow in a particular area. The controller can be set so that the snow removal equipment then returns to an initial position, for example, to a charging station. The snow removal equipment can be programmed to travel a pre-programmed route, learnt in advance by the user or not. Alternatively, it can also travel a random route within the boundaries of the area to be removed. The system may in some embodiments include a processor, a memory module and a remote control for control of the snow removal equipment by an operator, the processor being programmed to perform a calibration procedure upon first putting the snow removal equipment into service or when invoking a calibration period, the calibration procedure comprising the controlled travelling of a route and storing the route in the memory module for later use as a pre-programmed route during automated operation without operator. In some embodiments, the snow removal equipment comprises a wireless receiver for receiving signals from a corresponding remote control, the controller being connected to the wireless receiver and provided for moving the snow removal equipment based on the received commands. It is an advantage of some embodiments of the present invention that the snow removal equipment can be controlled remotely (e.g., by a person who is in a neighbouring building, while the snow removal equipment removes the snow outside). This remote control can also always be used in some embodiments, without the path travelled being stored for later autonomous control. In other embodiments, the operator must themselves complete the route with the snow removal equipment during calibration. For this purpose, a handle can be provided to control the snow removal equipment during the calibration. In some embodiments, the snow removal equipment is provided with detection means for detecting a boundary of the terrain or a position on the terrain. The detection means may comprise, for example, a metal detector, or a magnetic detector. The latter is e.g. useful if the terrain is demarcated with an electrical conductor. The detection means may also comprise, for example, a camera, e.g., an optical camera, or an infrared camera, or a time-of-flight camera (ToF camera). The detection means may comprise a camera in which the processor is programmed with an image processing algorithm provided with an object recognition module. It is an advantage of embodiments of the present invention that certain objects can be recognised (e.g., objects such as a post-box or a pole or the like) and that on this basis the processor can determine the position of the snow removal equipment on the terrain. The detection means may also comprise beacons that transmit radio waves, such that the position of the snow removal equipment can be determined by triangulation. Such beacons can be UWB signals. In some embodiments, the snow removal equipment is provided with a self-learning function for detecting a boundary of the terrain or a position on the terrain. Alternatively, the snow removal equipment can also be provided with a programmable module, it being possible to program the programmable module directly or remotely with the boundaries of the zone to be removed.

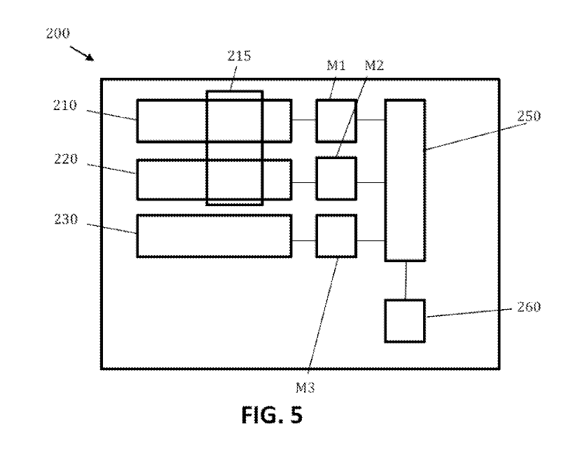

By way of illustration, FIG. 5 shows a block diagram of some elements of snow removal equipment according to embodiments of the present invention. It concerns a snow removal equipment 200, with a gathering unit 210, a disposal unit 220, propulsion means 230, and a motor M1, M2 and optionally M3 for driving the various elements. The system also comprises a controller 250 for controlling the driving of the different systems. The controller 250 receives from one or more sensors 260. Finally, the optional chamber 250 is also shown.

In another aspect, the present invention comprises a method for removing snow using the snow removal equipment as described in an embodiment of the first aspect. The method further comprises controlling a gathering unit adapted for gathering or shovelling snow on the terrain, and the removal of the gathered snow from the snow removal equipment, wherein the speed at which the gathering unit is driven and the speed at which the gathered snow is removed can be controlled separately. The speed at which the gathering unit is driven and the speed at which the gathered snow is removed can be controlled separately. In some embodiments, the method further comprises the automated driving of the snow removal equipment, without the intervention of an operator. The method may be such that the removing takes place in an autonomous manner, for example, at predetermined times, at times depending on weather forecasts, etc. In some embodiments, the method also comprises a calibration step. This can be initiated when first putting the snow removal equipment into use or when a calibration is invoked by the user. The calibration procedure may comprise one of several methods. The method may comprise a self-learning process, for example, based on a neural network, the self-learning process comprising determining the area to be removed and/or the route to be travelled. The method may alternatively comprise the controlled travelling of a route the route being stored in a memory module, making it available for later use. The method may further comprise all functionality corresponding to standard or optional elements of embodiments of the snow removal equipment from the other aspects of the present invention.

In yet another aspect, the present invention comprises a computer program product that provides the functionality of the methods according to embodiments of the present invention. The present invention also comprises a data carrier such as a CD-ROM, DVD, Blue-ray, a memory card or other carrier on which the computer program is stored in machine-readable form which, when executing the program, performs a method as described in one of the embodiments. The computer program can thus comprise one or more pieces of computer code. The present invention also comprises transmitting the computer program product over a network such as the internet or a corporate network. Such a computer program product may also comprise an update of control software. The computer program product may also be in the form of a microprocessor in which the computer program is stored.

In another aspect, a snow removal equipment is envisaged, comprising typical propulsion means allowing the snow removal equipment to move on a terrain, comprising a gathering unit adapted for gathering or shovelling snow on the terrain, and comprising a disposal unit to remove the gathered snow. However, the snow removal equipment according to embodiments of the present aspect is further adapted to comprise a heating element for heating snow or ice in the snow removal equipment. The heating element is thus positioned such that the snow or ice can be defrosted in those places where snow and ice typically get stuck the most in the snow removal equipment. In some embodiments, this is a chamber into which the snow is shovelled. In other embodiments, this is the transition zone between the gathering unit and the disposal unit. The heating element may be any type of heating element, such as, for example, a resistive element, a radiant element such as an infrared radiator, etc. It should be noted that the heating element can be implemented both in automated, autonomous, snow removal equipment, as well as in manual snow removal equipment. The heating element can be implemented in a snow removal equipment as described in the first aspect, but can also be implemented in conventional snow removal equipment. The heating element can be powered by an energy source that also covers one of the other functions, such as for example, that which drives the gathering unit, that which drives the disposal unit or that which guarantees the advancement of the snow removal equipment. Alternatively, a separate energy source may be provided for the heating element to function.

In some embodiments, a sensor system can be used to determine whether snow and ice are threatening to get stuck in critical locations and to activate the heating element if necessary. Thus, activation of the heating element can be automated, occur at predetermined times based on an algorithm or, for example, a self-learning system, be done manually, etc. The sensor system may be based on an optical system, for example, a system that can detect ice formation based on the absorption or reflection of an optical beam. The sensor system can also be based on the power the device needs to deliver to remove snow, a higher power typically indicating a partial blockage as typically occurs in the event of ice formation. The sensor system can also be based on another measurement principle.

In yet another aspect, the present invention comprises a snow removal equipment provided with a sensor system to perform an analysis of the snow which is positioned in front of the snow removal equipment. This sensor system allows the speed or the force with which the snow can be removed to be adjusted. For example, the speed or force used may depend on the snow height, the type of snow (e.g., powder snow versus compact snow), etc. In some embodiments, the speed at which the snow removal equipment moves can be adjusted. In some embodiments, the force with which the gathering unit works, which is provided for gathering/scraping the snow from the ground, can be adjusted. In some embodiments, both may be adjusted. In other embodiments, both are correlated. For example, the sensor system may consist of a light source, a detector and a processor. The reflection of light directed at a position in front of the snow removal equipment can be received with the detector, and in the processor it can then be calculated based on the received signal what the height of the snow is and what type of snow it is. Given the reflection coefficient depends on the height and type of snow, indeed, for example, an algorithm or LUT can be set up, so that the processor allows automatic identification of the snow situation. This system can be easily combined with the embodiments described in the other aspects.

In yet another aspect, a snow removal equipment is described as in the first aspect, but the speeds do not need to be controlled separately or independently. The characteristic aspect of the snow removal equipment is the fact that the snow removal equipment can remove autonomously, without the intervention of an operator. These characteristics are described in greater detail above.

1.-42. (canceled)

43. A snow removal equipment comprising:
means of propulsion allowing the snow removal equipment to move on a terrain,
a gathering unit adapted for gathering or shoveling snow on the terrain,
a disposal unit for removing the gathered snow,
the snow removal equipment being adapted to allow the speed at which the snow on the terrain is gathered, and the speed at which the gathered snow is removed, to be controlled separately.

44. The snow removal equipment according to claim 43, the snow removal equipment being an unmanned snow removal equipment.

45. The snow removal equipment according to claim 43, wherein the speed at which the snow on the terrain is gathered, and the speed at which the gathered snow is removed, can be controlled independently.

46. The snow removal equipment according to claim 43, the snow removal equipment additionally comprising a chamber,
wherein the gathering unit is adapted for transporting the gathered snow to a chamber, and
wherein the disposal unit is connected to the chamber and adapted to remove snow from the chamber.

47. The snow removal equipment according to claim 43, the snow removal equipment comprising a controller for coordinating the speed at which the snow on the terrain is gathered, with the speed at which the gathered snow is removed.

48. The snow removal equipment according to claim 43, the snow removal equipment comprising a motor for driving the gathering unit and a motor for driving the disposal unit, the motor for driving the gathering unit and the motor for driving the disposal unit being separately drivable.

49. The snow removal equipment according to claim 48, wherein the controller is adapted to individually control the speed at which the gathering unit is driven and the speed at which the disposal unit is driven, and
wherein the controller is programmed to reduce the speed at which the gathering unit is driven if the snow cannot be removed sufficiently quickly or
wherein the controller is programmed to increase the speed at which the disposal unit is driven if the snow cannot be removed sufficiently quickly.

50. The snow removal equipment according to claim 47, wherein the controller is adapted to slow down the snow-gathering engine with respect to the snow-removal engine and/or accelerate the snow-removal engine relative to the snow-gathering engine if the amount of snow gathered or shoveled by the gathering unit is greater than the amount of snow removed by the disposal unit.

51. The snow removal equipment according to claim 43, wherein a motor for driving the gathering unit can also be used for driving the propulsion means or wherein the snow removal equipment comprises one or more separate motors for driving the propulsion means.

52. The snow removal equipment according to claim 47, the controller being adapted to individually control the speed at which the propulsion means are driven and the speed at which the disposal unit is driven.

53. The snow removal equipment according to claim 47, wherein the controller is programmed to reduce the speed at which the propulsion means are driven if the snow cannot be removed sufficiently quickly or is programmed to set at least one intermediate speed between 0 km/h and the maximum speed for driving the propulsion means or for reversing the drive direction of the propulsion means so as to provide this movement in the opposite direction.

54. The snow removal equipment according to claim 43, the snow removal equipment comprising
a sensor or camera for detecting the accumulation of snow or ice formation,
the sensor comprising any of an optical sensor,
a laser,
a weight or pressure sensor,
a sensor for measuring the power output of the at least one engine for advancing the snow removal equipment,
a temperature sensor, or an ultrasonic sensor and the controller being programmed to control one or more motors based on an input signal from the at least one sensor.

55. The snow removal equipment according to claim 54, wherein the input signal indicates when the amount of snow in the chamber exceeds a predetermined value, when the fill ratio of the chamber is greater than a predetermined value, when the amount or flow rate or average flow rate of snow entering the chamber via the gathering unit is greater than the amount or flow rate of snow leaving the chamber via the disposal unit, or when ice formation is detected.

56. The snow removal equipment according to claim 43, the snow disposal unit being based on an Archimedean screw, a blowing system or a screw pump system.

57. The snow removal equipment according to claim 43, the snow removal equipment additionally comprising a brush for sweeping the surface, after snow has been gathered by means of the gathering unit or the snow removal equipment having at least one battery for supplying electric power.

58. The snow removal equipment according to claim 43, the snow removal equipment being provided with a processor, a memory module, and a remote control for control of the snow removal equipment by an operator,
the processor being programmed to perform a calibration procedure upon first putting the snow removal equipment into service or when invoking a calibration period,
the calibration procedure comprising the controlled travelling of a route and storing the route in the memory module for later use as a pre-programmed route during automated operation without operator or
wherein the snow removal equipment further comprises a wireless receiver for receiving signals from a corresponding remote control, the controller being connected to the wireless receiver and provided for moving the snow removal equipment based on the received commands.

59. The snow removal equipment according to claim 43, the snow removal equipment being provided with detection means for detecting a boundary of the terrain or a position on the terrain or being provided with a self-learning function for detecting a boundary of the terrain or a position on the terrain or being provided with a programmable module, it being possible to program the programmable module directly or remotely with the boundaries of the zone to be removed.

60. The snow removal equipment according to claim 43, the snow removal equipment being adapted for unmounting the gathering unit and mounting a lawn mower unit or a leaf blower or leaf vacuum unit, or a brush unit, or an aerating unit, or a water spraying unit.

61. A method for removing snow using the snow removal equipment according to claim 43, comprising the following steps:
driving an gathering unit adapted for gathering or shoveling snow on the terrain,
the removal of the gathered snow from the snow removal equipment,
wherein the speed at which the gathering unit is driven and the speed at which the gathered snow is removed can be controlled separately.

62. The method according to claim 61, wherein the speed at which the gathering unit is driven and the speed at which the gathered snow is removed can be controlled independently or
wherein the method further comprises the automated driving of the snow removal equipment without the intervention of an operator or
wherein the method comprises performing a calibration procedure upon first putting the snow removal equipment into service or
when invoking a calibration period, the calibration procedure comprising the controlled travelling of a route and/or comprising a self-learning process for learning a route and
the calibration procedure comprising storing the route in the memory module for later use as a pre-programmed route during automated operation without operator.
